(19) United States
(12) Patent Application Publication
(10) Pub. No.: US 2019/0085234 A1
(43) Pub. Date: Mar. 21, 2019

(54) PROCESS FOR PREPARING A SURFACTANT COMPOSITION

(71) Applicant: SHELL OIL COMPANY, HOUSTON, TX (US)

(72) Inventors: Timothy Elton KING, Katy, TX (US); Julian Richard BARNES, Amsterdam (NL); Paulus Johannes KUNKELER, Rotterdam (NL); Mark Lawrence BREWER, Amsterdam (NL)

(21) Appl. No.: 16/192,900

(22) Filed: Nov. 16, 2018

(51) Int. Cl. C09K 8/584; E21B 43/16

(52) U.S. Cl. CPC C09K 8/584; E21B 43/16

(57) ABSTRACT

The invention relates to a process for preparing a surfactant composition comprising an anionic surfactant and optionally an organic amine in which the molar ratio of the organic amine to the anionic surfactant is preferably at least 1:1 and in which the amount of water is at most 40% by weight, which process comprises contacting an organic amine and an acid precursor of the anionic surfactant (“acid surfactant precursor”) by adding the acid surfactant precursor to the organic amine, wherein the molar ratio of the organic amine to the total amount of added acid surfactant precursor is at least 1:1, preferably at least 2:1, and the amount of water is at most 40% by weight based on total amount of mixture.

### FIELD OF THE INVENTION

The present invention relates to a process for preparing a surfactant composition and a process for recovering oil with the help of such surfactant composition.

### BACKGROUND OF THE INVENTION

In the recovery of oil from a subterranean formation, it is possible to recover only a portion of the oil in the formation using primary recovery methods utilizing the natural formation pressure to produce the oil. A portion of the oil that cannot be produced from the formation using primary recovery methods may be produced by improved or enhanced oil recovery (EOR) methods.

An enhanced oil recovery method utilizes an alkaline surfactant flood in an oil-bearing formation to increase the amount of oil recovered from the formation. In such process, an aqueous dispersion of an alkali and a surfactant is injected into an oil-bearing formation to increase recovery of oil from the formation, either after primary recovery or after a secondary recovery waterflood. The surfactant flood enhances recovery of oil from the formation by lowering interfacial tension between oil and water phases in the formation, thereby mobilizing the oil for production. Interfacial tension between the oil and water phases in the formation is reduced by the surfactant of the flood and by the formation of soaps by alkali interaction with acids in the oil.

Use of alkaline surfactant enhanced oil recovery to recover oil may, however, be constrained by the amount of space available as storage facilities must be provided for each the surfactant and the alkali. Additionally, the separate transport and supply of each surfactant can be cumbersome from a logistical point of view.

Alkalis most commonly used as the alkali in enhanced oil recovery processes include hydroxides and carbonates, and the most common alkali is sodium carbonate.

In oil-bearing formations containing a significant concentration of calcium ions dispersed in water and/or oil in the formation or dispersed along the surfaces of the formation, use of an alkali such as a carbonate in an alkaline surfactant flood enhanced oil recovery process contributes to the build-up of scale in production well strings. Water-soluble alkalis used in an alkaline surfactant flood such as sodium carbonate react with calcium from the formation water, oil, or surfaces to form calcium carbonate. Contact of the alkali carbonate of the alkaline surfactant flood with calcium in the formation near the production well induces the formation of calcium carbonate, some of which precipitates and deposits as scale in the production well strings. When the calcium content of a formation is high, such scale deposition may require that the production string either be periodically treated to remove the scale or that the production string be periodically replaced.

EP3168277 describes a synthetic anionic sulphur-containing surfactant composition prepared by contacting a surfactant precursor with ammonia liquid applied in an amount in excess to that required for stoichiometric neutralization of the surfactant precursor. The ammonia preferably is anhydrous liquid. Unfortunately, some ammonia neutralized surfactant compositions were found to have less favourable properties when applied in enhanced hydrocarbon recovery.

WO200042140 describes anionic surfactant compositions which can be neutralized by the addition of a basic compound such as alkanolamines, alkyl amines, ammonium hydroxide, NaOH, KOH and mixtures thereof.

Surfactant compositions for enhanced hydrocarbon recovery are transported to a hydrocarbon recovery location and stored at that location in the form of an aqueous solution containing for example 30 to 35 wt. % of the surfactant. At the hydrocarbon recovery location, such surfactant solution will then be further diluted to a 0.1-1 wt. % surfactant concentration in the solution to be injected into the hydrocarbon containing formation. Having to transport 30-35 wt. % surfactant containing aqueous solutions thus involves the transport of substantial volumes of water to hydrocarbon recovery locations which may be very remote from the location where the surfactants were synthesized and/or which hydrocarbon recovery locations may not be easily accessible. However, it is generally considered unavoidable because water has to be present during manufacture of the surfactant composition to complete synthesis of the surfactant or to dissolve one or more of the compounds such as the alkaline agent.

Further, surfactants for enhanced hydrocarbon recovery preferably are injected into a hydrocarbon containing formation as part of a single-phase solution. Formation of precipitate, liquid crystal or a second liquid phase can lead to non-uniform distribution of injected material and non-uniform transport owing to phase trapping or different mobilities of coexisting phases.

It is desired to prepare a surfactant composition which generates a sufficiently low interfacial tension between crude oil and water preferably at a variety of conditions. It is further desirable that such surfactant composition can be provided to a hydrocarbon containing formation as part of a single-phase solution. Another object would be to substantially reduce the amount of water present in the surfactant composition which is to be transported and stored. Another object is not to have to transport and store alkali and surfactant separately. A preferred object is to achieve several and preferably all of the objectives mentioned in this paragraph.

### SUMMARY OF THE INVENTION

Surprisingly it was found that one or more of the above objects may be achieved by adding an acid precursor of an anionic surfactant (“acid surfactant precursor”) to an organic amine, instead of adding the organic amine to the acid surfactant precursor, and ensuring that the molar ratio of the organic amine to the total amount of added acid surfactant precursor is at least 1:1, preferably at least 2:1, and the amount of water is at most 40% by weight based on total amount of mixture.

Accordingly, the present invention relates to a process for preparing a surfactant composition comprising an anionic surfactant and optionally an organic amine in which the molar ratio of the organic amine to the anionic surfactant is preferably at least 1:1 and in which the amount of water is at most 40% by weight,

which process comprises contacting an organic amine and an acid precursor of the anionic surfactant (“acid surfactant precursor”) by adding the acid surfactant precursor to the organic amine, wherein the molar ratio of the organic amine to the total amount of added acid surfactant precursor is at least 1:1, preferably at least 2:1, and the amount of water is at most 40% by weight based on total amount of mixture.

Further, the invention relates to a process for recovering oil from an oil-bearing formation wherein such surfactant composition is used.

### DETAILED DESCRIPTION OF THE INVENTION

The present surfactant composition comprises an anionic surfactant (hereinafter also referred to as “surfactant”) and optionally an organic amine in which the molar ratio of the organic amine to the anionic surfactant is preferably at least 1:1 and in which the amount of water is at most 40% by weight.

The amount of organic amine is the total amount of the organic amine present in the surfactant composition. The amount of surfactant is the total amount of surfactant present in the surfactant composition.

The surfactant composition preferably is a hydrocarbon recovery surfactant composition. This term means that the composition is suitable for hydrocarbon recovery from an oil-bearing formation.

In the present invention, the composition preferably is in the liquid state. The temperature at which the composition is to be liquid can range from −10 to +100° C., more specifically of from 0 to 50° C., depending on the surface operating conditions at the hydrocarbon recovery location. Generally, the liquid state is meant the state of the composition at a temperature of 20° C. and atmospheric pressure.

Within the present specification, a compound may be characterised by its carbon number and/or molecular weight. In case reference is made to an average carbon number and/or average molecular weight, this means weight average. The average carbon number may be determined by NMR analysis.

Formulas in this specification represent a single molecule or class of molecules. If different molecules are present, the weight average numbers are to be used.

The organic amine can be any compound known to the skilled person to be suitable for dissolving surfactant and providing sufficient alkalinity to provide an appropriately low interfacial tension between crude oil and injected surfactant composition. The organic amine contains at least 1 amine group, preferably of from 1 to 6, most preferably 1 or 2 amine groups. The organic amine can contain any number of hydrogen and carbon atoms optionally in combination with hetero-atoms and can be acylic, cyclic, linear and branched. Preferably, the organic amine contains of from 2 to 10 carbon atoms, more specifically of from 2 to 6 carbon atoms, more specifically of from 2 to 4 carbon atoms. Preferably, the organic amine is N—R₁R₂R₃ wherein R₁ and R₂ independently are H or according to R₄; R₃ is according to R₄ and R₄ is CₙH₂ₙ₊₁ or (CₘH₂ₘO)ₓH where n=1, 2, 3 or 4, m=2, 3 or 4 and x=1, 2 or 3 wherein R₁, R₂ and R₃ each can be a different group in accordance with R₄. The organic amine can be a mixture of two or more of the foregoing and/or following organic amines.

The organic amine preferably is selected from the group consisting of monoethanolamine, diethanolamine, triethanolamine, monoisopropanolamine, N-methyldiethanolamine, N-methylethanolamine, dimethylethanolamine, 2-(2-aminoethoxy) ethanol, ethylenediamine and morpholine. The organic amine more preferably is selected from the group consisting of monoethanolamine, diethanolamine and triethanolamine Most preferably, the organic amine is monoethanolamine.

A suitable group of organic amines are the branched alkoxyamines, more specifically the group consisting of monoisopropanolamine and di-isopropanolamine.

A suitable group of organic amines are the tertiary amines, more specifically the group consisting of N-methyldiethanolamine and dimethylethanolamine.

A suitable group of organic amines are the secondary amines more specifically the group consisting of N-methylethanolamine, diethanolamine and diethylamine, preferably consisting of N-methylethanolamine and diethanolamine.

A suitable group of organic amines are the primary amines more specifically the group consisting of monoethanolamine and isopropylamine, most specifically monoethanolamine. A suitable group of organic amines are the diamines, more specifically ethylenediamine.

A suitable group of organic amines are the cyclic amines more specifically morpholine.

A suitable group of organic amines are the aromatic amines more specifically aniline.

The organic amine preferably is soluble in water. Preferably, the organic amine has a pKa of at least 7, more preferably at least 8. Preferably, the organic amine has a pKa of at most 10, more preferably at most 9, more preferably at most 8. Preferably, the molecular weight of the organic amine is at least 50, more preferably at least 60, more preferably at least 63, more preferably at least 75. Preferably, the molecular weight of the organic amine is at most 500, more preferably at most 400, more preferably at most 300, more preferably at most 200, more preferably at most 150, more preferably at most 100, more preferably less than 100, more preferably less than 80. The organic amine preferably is liquid at the operating conditions at which it is to be applied of which the temperature can range from −30 to +100° C., more specifically of from −10 to +100° C., more specifically of from 0 to 50° C. Generally, the organic amine is liquid at a temperature of 20° C. Further, the organic amine is preferably liquid at atmospheric pressure.

Although it is possible that a variety of organic amines are present, it is generally preferred that a single kind of organic amine is present.

As used in the present specification, the cation of the organic amine is a compound which only differs from the original organic amine in that one or more amines have been replaced by ammonium.

The surfactant composition comprises surfactant and optionally organic amine in a molar ratio of organic amine to surfactant which is preferably at least 1:1, more specifically more than 1:1, more specifically at least 1.5:1, more particularly at least 2:1, more particularly at least 3:1, more particularly at least 4:1, more particularly at least 5:1, more particularly at least 6:1, more particularly at least 7:1, more particularly at least 8:1. The molar ratio of organic amine to surfactant generally will be at most 500:1, more specifically at most 200:1, more specifically at most 100:1, more specifically at most 50:1, more specifically at most 40:1, more specifically at most 30:1, more specifically at most 25:1, more specifically at most 22:1, more specifically at most 20:1, more specifically at most 18:1, more specifically at most 15:1, more specifically at most 13:1, more specifically at most 10:1. Surfactant present in the surfactant composition contains cation of the organic amine. These are to be disregarded for calculating the amount of organic amine present in the surfactant composition.

The preferred molar ratio of organic amine to surfactant depends on the specific circumstances. If the oil in the formation contains a relatively large amount of compounds which can be converted into soap, such as oil having a high Total Acid Number (TAN), the surfactant composition can have a relatively higher organic amine to surfactant ratio. A higher amount of organic amine is also desired if a substantial amount of organic amine will be lost in rock retention and adsorption in the formation.

The surfactant composition preferably comprises at least 30% wt, more preferably at least 40% wt, more preferably at least 50% wt, more preferably at least 60% wt, more preferably at least 70% wt, more preferably at least 80% wt, more preferably at least 85% wt, more preferably at least 90% wt, more preferably at least 95% wt of organic amine. The amount of organic amine generally will be at most 99.5% wt, more specifically at most 99% wt, more specifically at most 98% wt, more specifically at most 95% wt, more specifically at most 90% wt, more specifically at most 85% wt, more specifically at most 80% wt. All these amounts are amounts of organic amine based on total amount of surfactant formulation while disregarding cation of the organic amine which the surfactant contains.

In the present invention, the surfactant composition contains either no water or only a limited amount of water, namely of from 0 to at most 40% by weight (% wt), more particularly of from 0 to at most 30% wt, more particularly at most 20% wt, more particularly at most 10% wt, more particularly at most 7% wt, more preferably at most 5% wt. The amount of water in the present surfactant composition may be 0% wt or at least 0.01% wt or at least 0.05% wt or at least 0.1% wt or at least 0.2% wt or at least 0.25% wt or at least 0.3% wt. Further, the amount of water in the present surfactant composition is at most 40% wt or may be at most 30% wt or at most 20% wt or at most 10% wt or at most 7% wt or at most 5% wt or at most 3% wt or at most 2% wt or at most 1% wt or at most 0.5% wt or at most 0.3% wt or at most 0.2% wt or at most 0.1% wt.

The amount of water is based on total amount of all compounds present in the surfactant composition including but not limited to surfactants, organic amine, water and any other compound which may be present.

The surfactant composition preferably comprises at least 2% wt of surfactant, more preferably at least 5% wt of surfactant, more preferably at least 10% wt of surfactant, more preferably at least 15% wt of surfactant, more preferably at least 20% wt of surfactant. The amount of surfactant preferably is at most 80% wt, more preferably at most 70% wt, more preferably at most 60% wt, more preferably at most 50% wt, more preferably at most 40% wt, more preferably at most 30% wt based on total amount of all compounds present in the surfactant composition.

Preferably, the surfactant composition comprises from 50 to 98% wt of organic amine and from 2 to 50% wt of surfactant which composition can contain further compounds including water. Most preferably, the surfactant composition consists of from 50 to 98% wt of organic amine, from 2 to 50% wt of surfactant and from 0 to 10% wt of water.

A surfactant is any compound which stabilises mixtures of oil and water by reducing the interfacial tension at the interface between the oil and water molecules. A surfactant generally comprises a hydrophilic part and a hydrophobic part. The present surfactant composition contains an anionic surfactant. When the hydrophilic part of a surfactant comprises a negatively charged group like phosphonate, phosphate, sulfonate, sulphate or carboxylate, the surfactant is called anionic. Further, an anionic surfactant comprises a counter cation to compensate for this negative charge.

An anionic surfactant generally has the following formula (I) [S^{m-}] [Mⁿ⁺]ₒ wherein S is the negatively charged portion of the anionic surfactant and M is a counter cation. In the formula (I), m and n are integers. m may be 1, 2 or 3. For a variety of compounds for which a weight average is to be used, m and n can be of from 1 to 3. Further, o may be any number which ensures that the anionic surfactant is electrically neutral. That is to say, the product of n and o (n*o) should equal m. o may be a number in the range of from 0.25 to 3, preferably 0.5 to 3. Said negatively charged portion S thus comprises (i) the hydrophilic part, which comprises a negatively charged group, and (ii) the hydrophobic part of the anionic surfactant. In the present invention, the counter cation, denoted as Mⁿ⁺, is the cation of the added organic amine.

A suitable class of anionic surfactants are the surfactants of the following formula (II)

[RV—[R′—O]ₓ- A^{m-}] [Mⁿ⁺]ₒ (II)

wherein R is hydrogen or an organic group, V is a heteroatom, preferably O or N (wherein N can be NH), R′—O is an alkylene oxide group originating from alkylene oxide, x is 0 or more, A is a negatively charged group which may consist of one or more negatively charged components with the negative charge of all components together being m, M is a counter cation and the product of n and o (n*o) equals m, wherein said counter cation is the cation of the added organic amine. Preferably, x is of from 0 to 100, more specifically of from 0 to 30, more specifically of from 0 to 20, more specifically of from 0 to 14, more specifically of from 0 to 8. R can have a total number of from 5 to 100 and can be based on a Guerbet alcohol more specifically a 2-alkyl-1-alkanol having a total number of carbon atoms of from 10 to 50 or on tristyrylphenol. In the above exemplary formula (II), m and n are integers. m may be 1, 2 or 3. For a variety of compounds for which a weight average is to be used, m and n can be of from 1 to 3. Further, o may be any number which ensures that the anionic surfactant is electrically neutral. That is to say, the product of n and o (n*o) should equal m. o may be a number in the range of from 0.25 to 3, preferably 0.5 to 3.

The alkylene oxide groups in above exemplary formula (II) may comprise any alkylene oxide groups. For example, said alkylene oxide groups may comprise ethylene oxide groups, propylene oxide groups and butylene oxide groups or a mixture thereof, such as a mixture of ethylene oxide and propylene oxide groups. In case of a mixture of ethylene oxide and propylene oxide groups and optionally butylene oxide groups, the mixture may be random or blockwise. In particular, the alkylene oxide groups in above exemplary formula (II) may comprise or consist of propylene oxide or ethylene oxide or butylene oxide. Further, said alkylene oxide groups may comprise or consist of a random mixture of propylene oxide and ethylene oxide and optionally butylene oxide. Further, said alkylene oxide groups may comprise or consist of a propylene oxide block, adjacent to the RV-moiety in said formula (II), followed by an ethylene oxide block. Further, said alkylene oxide groups may comprise or consist of an ethylene oxide block, adjacent to the RV-moiety in said formula (II), followed by a propylene oxide block. The negatively charged group, denoted as A^{m-} in above exemplary formula (II), may be any negatively charged group. Said negatively charged group is preferably a —SO₃⁻ moiety (either sulfate or sulfonate). Further, said negatively charged group may be a group comprising the —C(═O)O⁻ moiety (carboxylate).

The anionic surfactant in the surfactant composition of the present invention may be any one of the anionic surfactants, or a mixture of such surfactants, that are known to effect recovery of hydrocarbons from hydrocarbon containing formations.

Preferably, the anionic surfactant in the composition of the present invention is selected from the group consisting of:
a) alkyl aryl sulfonates,
b) alkyl carboxylates;
c) alkyl alkoxy carboxylates;
d) alkyl alkoxy sulphates;
e) alkyl sulphates;
f) internal and alpha olefin sulfonates;
g) alkyl alkoxy glyceryl ether sulfonates; and
h) any mixture of the foregoing anionic surfactants.

More preferably, the anionic surfactant in the composition of the present invention is selected from the group consisting of a surfactant as mentioned under a) above, a surfactant as mentioned under b) above, a surfactant as mentioned under c) above or any mixture of said surfactants. These compounds have the advantage that these can be manufactured by neutralizing the corresponding acid with the organic amine in the presence of no or only a limited amount of water. In this way, advantageously, an intermediate step of neutralizing the acid form of the surfactant with for example NaOH, resulting in the sodium form of the surfactant, may be omitted. Most preferably, the anionic surfactant in the composition of the present invention is a surfactant as mentioned under a) above.

Surfactants as mentioned under a) can have attached a linear or branched alkyl group, preferably a predominantly linear alkyl group, for example C₁₀-C₃₀ preferably C₁₅-C₁₈ alkyl group, either via its terminal carbon atom or an internal carbon atom, to a benzene molecule which benzene molecule is also substituted with a sulfonate group on another position, preferably at the para position, and which benzene molecule may be further substituted at the remaining positions, for example with alkyl groups, such as a methyl group or ethyl group to form toluene or xylene or a derivative thereof. Examples of suitable alkyl aryl sulfonates that can be used as anionic surfactant in the present invention are disclosed in U.S. 20090163669. U.S. 20090163669 describes tri-alkyl substituted benzene sulfonates, such as the sulfonates of the alkylation product of ortho-xylene with a mixture of C₁₂-C₃₀⁺ linear alpha-olefins. Examples of suitable alkyl aryl sulfonates that can also be used as anionic surfactant in the present invention are disclosed in WO200042140. Examples of suitable alkylaryl sulfonates or sulphonic acids are dodecyl benzene sulfonate, dodecyl benzene sulfonic acid, XOF-20S, XOF-22S, XOF-23S, XOF-25S, XOF-26S, XOF-30S, XOF-20A, XOF-22A, XOF-23A, XOF-25A, XOF-26A, XOF-30A as commercially available from Huntsman Chemicals, Aristonate L, Aristonate M, Aristonate H, Aristonate VH2, Calsoft LAS-99, Pilot EM-99 as commercially available from Pilot Chemical, ENORDET LTS-18 linear alkyltoluene sulfonate surfactant as commercially available from Shell Chemicals, Petrostep A6, Biosoft S101, Biosoft LA Acid, Biosoft 411 E, Biosoft N300, Biosoft G-3300 as commercially available from Stepan, and Soloterra 117H as commercially available from Sasol.

The alkyl-carboxylates mentioned under b) are derived from alkyl-carboxylic acids having the general formula R[COOH]_{b}. R is a hydrocarbon chain predominantly containing C and H but can also contain heteroatoms. R can be acyclic, linear, branched, cyclic or aromatic. R contains from 8 to 100 carbon atoms and b can be 1, 2 or 3. Preferably, the number of carbon atoms is at most 75, more specifically at most 50, more specifically at most 35, more specifically at most 25, more specifically at most 14. The alkyl-carboxylic acids can be from natural or petrochemical feedstock.

These anionic surfactants of b) can be directly derived from fatty acids. The alkyl carboxylates may be derived from any fatty acid or mixture of fatty acids. Its fatty acid component(s) are preferably derived from a biological source, more preferably a vegetable source. They may be saturated or unsaturated; if the latter, they may have one or more, preferably up to 6, double bonds. They may be linear or branched, cyclic or polycyclic. Suitably they will have from 6 to 30, preferably 10 to 30, more suitably from 10 to 22 or from 10 to 18 carbon atoms including the acid group(s) —CO₂H. A fatty acid will typically comprise a mixture of different fatty acids of different chain lengths, depending on its source.

The fatty acid used in the present invention is preferably derived from tall oil, vegetable fatty acids and/or animal fatty acids.

In a preferred embodiment, the fatty acid composition contains fatty acids derived from plant sources such as tall oil and/or vegetable oils. A preferred composition contains less than 5%, preferably less than 3% saturated fatty acids calculated on the total weight of said fatty acids composition and more than 90%, preferably more than 95%, more preferably more than 98% unsaturated fatty acids calculated on the total weight of said fatty acids.

In another preferred embodiment, the fatty acid composition contains rosin acids derived from plant sources such as tall oil. A preferred composition contains more than 2% wt, preferably more than 5% wt, preferably more than 10% wt, preferably more than 20% wt, most preferably more than 30% wt rosin acids calculated on the total weight of fatty acid. Rosin acids are monocarboxylic diterpene acids, the most common of which has the molecular formula C₂₀H₃₀O₂. The rosin-based acids can be selected from abietic acid, dihydroabietic acid, dehydroabietic acid, neoabietic acid, pimaric acid, levopimaric acid, palustric acid, isopimaric and other derivatives based on the diterpene structure which can be present as mixtures. The rosin acids can be obtained from tall oil or gum rosin.

The surfactants mentioned under c) may be derived from a fatty acid by converting the carboxylate group of the original fatty acid to an alcohol and subsequent alkoxylation and carboxylation to obtain the alkyl alkoxylated carboxylic acid.

The anionic surfactant mentioned under f) above can be an internal olefin sulfonate. The average carbon number for the such internal olefin sulfonate may vary within wide ranges, such as from 5 to 40, suitably 10 to 35, more suitably 15 to 32. Internal olefin sulfonates are made from an internal olefin molecule whose double bond is located anywhere along the carbon chain except at a terminal carbon atom. Internal olefin molecules may be made by double bond isomerisation of alpha-olefin molecules whose double bond is located at a terminal position. Generally, such isomerisation results in a mixture of internal olefin molecules whose double bonds are located at different internal positions. The mixture that results from such preparation may also comprise a minor amount of alpha-olefins, for example up to 5%, suitably up to 3%. Internal olefins can be converted into the corresponding anionic surfactants in any way known to be suitable by the person skilled in the art.

Internal olefin sulfonates may have a weight ratio of branched internal olefin sulfonates molecules to linear internal olefin sulfonates molecules which is greater than 0 to smaller than 11:89. Branched internal olefin sulfonates molecules are internal olefin sulfonates molecules derived from internal olefin molecules which comprise one or more branches. Linear internal olefin sulfonates molecules are internal olefin sulfonates molecules derived from internal olefin molecules which are linear, that is to say which comprise no branches (unbranched internal olefin molecules). Said weight ratio of branched internal olefin sulfonates molecules to linear internal olefin sulfonates molecules may be determined by gas chromatography (GC). Further, said determination may be performed on the internal olefin sulfonates precursor, that is to say on the olefin mixture before it is sulfonated. Preferably, said weight ratio of branched internal olefin sulfonates molecules to linear internal olefin sulfonates molecules is greater than 0 to smaller than 10:90, more preferably of from 0.1:99.9 to 9:91, even more preferably of from 1:99 to 8:92, and most preferably of from 2:98 to 7:93.

Branches in the above-mentioned branched internal olefin sulfonates molecules may include methyl, ethyl and/or higher molecular weight branches including propyl branches. Methyl branches may represent from 5 to 50%, more suitably from 10 to 40%, most suitably from 15 to 30%, of the total number of branches. Ethyl branches may represent from 10 to 60%, more suitably from 20 to 50%, most suitably from 25 to 40%, of the total number of branches. Other (higher molecular weight) branches other than methyl or ethyl may represent from 15 to 70%, more suitably from 30 to 60%, most suitably from 35 to 50%, of the total number of branches. Said percentages may be determined by 13C-NMR analysis. Further, said determination is preferably performed on the internal olefin sulfonates precursor, that is to say on the olefin mixture before it is sulfonated.

The average carbon number for the internal olefin sulfonates may vary within wide ranges, such as from 5 to 40, suitably 10 to 35, more suitably 15 to 30, most suitably 18 to 24. Further, the average molecular weight for the internal olefin sulfonates is neither essential and may also vary within wide ranges, such as from 100 to 500, suitably 150 to 450, more suitably 200 to 400 g/mole, most suitably 250 to 350 g/mole.

The surfactant can be any combination of surfactants containing at least one of the foregoing anionic surfactants or mixture of anionic surfactants. The anionic surfactant can be a mixture of two or more of the foregoing anionic surfactants.

In the present process for preparing the above-described surfactant composition, comprising an anionic surfactant and optionally an organic amine in which the molar ratio of the organic amine to the anionic surfactant is preferably at least 1:1 and in which the amount of water is at most 40% by weight, the organic amine and an acid precursor of the anionic surfactant (“acid surfactant precursor”) are contacted by adding the acid surfactant precursor to the organic amine, wherein the molar ratio of the organic amine to the total amount of added acid surfactant precursor is at least 1:1, preferably at least 2:1, and the amount of water is at most 40% by weight based on total amount of mixture. In the present invention, it is required that the acid surfactant precursor is added to the organic amine, instead of adding the organic amine to the acid surfactant precursor.

The present surfactant composition can be prepared by mixing acid surfactant precursor and organic amine optionally in the presence of water. The amount of water can be limited due to the presence of the organic amine to which the acid surfactant precursor is added. Additional compounds such as polymers, scale inhibitors, paraffin inhibitors and co-solvents can be incorporated in the surfactant composition or can be incorporated later when the hydrocarbon recovery formulation is prepared.

Surprisingly, it has been found that a mixture of organic amine and anionic surfactant, more especially hydrocarbon recovery anionic surfactant, has a viscosity which makes it easy to mix, transport and store. Further, it has been found that an acid surfactant precursor can be converted into the corresponding anionic surfactant by adding it to an organic amine while at the same an excess organic amine may be provided which is required for hydrocarbon recovery at a later stage. Therefore, in the present invention, organic amine is preferably advantageously used both for preparing the anionic surfactant, namely when neutralizing the acid surfactant precursor, and for incorporating alkalinity. Thus, the present surfactant composition comprises (i) organic amine and (ii) anionic surfactant comprising the cation of the organic amine as the cationic counterion.

Thus, in the present surfactant composition preparation process the acid surfactant precursor is neutralized by adding it to the organic amine by which it is converted into an anionic surfactant comprising the cation of the organic amine as the cationic counterion, in the presence of no or only a limited amount of water. Such use of an organic amine has the advantage that an intermediate step of neutralizing the acid surfactant precursor with for example sodium hydroxide (NaOH) may be omitted. Besides, in case organic amine is used in an excess, such additional amine is needed any way to provide alkalinity as required for hydrocarbon recovery at a later stage.

Normally, during manufacture of anionic surfactants, such as the above-mentioned alkyl aryl sulfonates, an acid surfactant precursor (e.g. alkyl aryl sulfonic acid) in a relatively high concentration of for example 90 wt. % and higher is first manufactured. Typically, this acid surfactant precursor is then neutralized, which involves the introduction of a base. A common base in surfactant manufacture is aqueous sodium hydroxide (NaOH), in particular a 50 wt. % sodium hydroxide solution in water, which is the highest concentration of aqueous NaOH industrially produced. The introduction of water when using aqueous NaOH results in a lower surfactant concentration in the final product, which results in increased transport costs through shipping water.

The dilution with aqueous NaOH not only results in a product with a lower surfactant concentration but also a product that is highly viscous. In the present surfactant composition preparation process, where the acid surfactant precursor may be added to 100% concentrated organic amine, e.g. monoethanolamine (MEA), as the base instead of adding a diluted NaOH solution to the acid surfactant precursor, a highly concentrated product (surfactant composition) is formed. Transporting such concentrated, handleable surfactant containing liquid product, results in an appreciable reduction in logistical costs and an overall simplification of the logistical operation for chemical enhanced oil recovery (EOR) field deployment, in particular also because in the present invention the liquid surfactant composition may already contain additional (excess) alkali (i.e. organic amine) needed to provide alkalinity for oil recovery.

In the present invention, the surfactant composition is handleable inter alia because the surfactant composition comprising surfactant and organic amine is in a single phase (i.e. homogeneous mixture). As mentioned above, surfactants for enhanced hydrocarbon recovery preferably are injected into a hydrocarbon containing formation as part of a single-phase solution. Formation of precipitate, liquid crystal or a second liquid phase can lead to non-uniform distribution of injected material and non-uniform transport owing to phase trapping or different mobilities of coexisting phases.

As mentioned above, in the present invention, it is required that the acid surfactant precursor is added to the organic amine, instead of adding the organic amine to the acid surfactant precursor. Exotherms or heat generation are common when mixing an acid and a base and this may impact the neutralized product appearance or quality. In the present invention, this is advantageously minimized by applying a specific mixing order, namely by adding the acid surfactant precursor having a relatively high viscosity to the organic amine having a relatively low viscosity (and not in the reverse order), thereby requiring no or substantially less cooling. Thus, in the present invention, adding the acid surfactant precursor to the organic amine in such amounts that the molar ratio of the organic amine to the total amount of added acid surfactant precursor is at least 1:1 (stoichiometric amount or higher) advantageously results in a single-phase liquid surfactant containing composition with minimal exotherms. Preferably, in the present invention, more organic amine, preferably at least 2:1, is used to prepare the surfactant composition, as the organic amine apart from being used initially as a neutralizing agent to produce the anionic surfactant, it is advantageously also used as an alkali at a later stage (in hydrocarbon recovery). The present process may therefore also allow the mixing of the acid surfactant precursor and the organic amine under near adiabatic conditions. Reduction of heat evolution gives flexibility in the use of hardware and equipment (vessels, mixing method and heat removal).

In the present surfactant composition preparation process, the acid surfactant precursor may be added all at once to the organic amine. However, preferably, it is added incrementally to the organic amine. Further, in the present invention, the surfactant composition may be produced in a batch process, semi-batch process or continuous process, preferably a batch process, for example by incrementally feeding the acid surfactant precursor to a vessel containing the organic amine. In a continuous process, a stream comprising the acid surfactant precursor having a lower flow rate may be added to a stream comprising the organic amine having a higher flow rate (e.g. in-line mixing, followed by storage in a vessel).

In the above-mentioned surfactant composition preparation process, the molar ratio of the organic amine to the total amount of added acid surfactant precursor is at least 1:1, preferably at least 2:1, more specifically more than 2:1, more specifically at least 2.5:1, more particularly at least 3:1, more particularly at least 4:1, more particularly at least 5:1, more particularly at least 6:1, more particularly at least 7:1, more particularly at least 8:1, more particularly at least 9:1. The molar ratio of the organic amine to the total amount of added acid surfactant precursor generally will be at most 500:1, more specifically at most 200:1, more specifically at most 100:1, more specifically at most 50:1, more specifically at most 40:1, more specifically at most 30:1, more specifically at most 25:1, more specifically at most 22:1, more specifically at most 20:1, more specifically at most 18:1, more specifically at most 15:1, more specifically at most 13:1, more specifically at most 10:1.

The person skilled in the art will be aware of suitable operating conditions for such process. Preferably, the acid surfactant precursor is contacted with the organic amine at a temperature in the range of from 0 to 100° C. The pressure can vary widely but preferably ambient pressure is used. Due to the presence of organic amine to which the acid surfactant precursor is added, the amount of water can be limited. Further, in the present surfactant composition preparation process, the amount of water is of from 0 to at most 40% by weight (% wt), based on total amount of mixture. In said process, either no water or only a limited amount of water, namely of from 0 to at most 40% by weight (% wt), more particularly of from 0 to at most 30% wt, more particularly at most 20% wt, more particularly at most 10% wt, more particularly at most 7% wt, more preferably at most 5% wt is present. Said amount of water in said process may be 0% wt or at least 0.01% wt or at least 0.05% wt or at least 0.1% wt or at least 0.2% wt or at least 0.25% wt or at least 0.3% wt. Further, said amount of water in said process is at most 40% wt or may be at most 30% wt or at most 20% wt or at most 10% wt or at most 7% wt or at most 5% wt or at most 3% wt or at most 2% wt or at most 1% wt or at most 0.5% wt or at most 0.3% wt or at most 0.2% wt or at most 0.1% wt. The amount of water is based on total amount of all compounds present in the surfactant composition including but not limited to surfactants, organic amine, water and any other compound which may be present.

Further, the present invention relates to a process for recovering oil from an oil-bearing formation, comprising the steps of:

(a) mixing with water a surfactant composition obtained by the above-described process to form a hydrocarbon recovery formulation;

(b) injecting the hydrocarbon recovery formulation as obtained in step (a) into the oil-bearing formation; and

(c) producing oil from the oil-bearing formation.

Step (a) can additionally comprise adding one or more compounds selected from the group consisting of polymers and co-solvents. The preferred molar ratio of organic amine to surfactant in step (b) is the ratio as described above for the surfactant composition.

The oil in the above-mentioned oil-bearing formation in the oil recovery process of the present invention may have a Total Acid Number (TAN) of from 0.1 to 3 or 0.5 to 3.5 mg KOH/g. In particular, said TAN may be 0 or at least 0.1 or at least 0.2 or at least 0.3 or at least 0.4 or at least 0.5 mg KOH/g. Further, in particular, said TAN may be at most 10 or at most 8 or at most 6 or at most 5 or at most 4.5 or at most 4 or at most 3.5 or at most 3 or at most 2.5 or at most 2 or at most 1.5 or at most 1 or at most 0.5 mg KOH/g. The TAN is a measurement of acidity that is determined by the amount of potassium hydroxide (KOH) in milligrams that is needed to neutralize the acids in one gram of oil.

Any water can be used in step a) of this process. The use of pure water can be preferred but pure water is not always available in sufficient quantity. Pure water is considered to be water having a total dissolved solids content (TDS, measured according to ASTM D5907) of at most 5000 ppm, more specifically at most 2000 ppm, more specifically at most 1000 ppm, most specifically at most 500 ppm. The expression “ppm” indicates parts per million by weight on total weight amount present.

In case pure water is not readily available, an alternative preferred embodiment is to apply a combination of pure water and water having a relatively high TDS or use water from other sources such as sea water, brackish water, aquifer water, formation water and brine. Water which can be used with the surfactant formulation generally has a TDS of more than 1,000 ppm, more specifically at least 2,000 ppm, more specifically at least 4,000 ppm, more specifically at least 5,000 ppm. Preferably, the water has a TDS of less than 20,000 ppm, more specifically less than 15,000 ppm, more specifically is at most 10,000 ppm, most specifically at most 8,000 ppm. Most preferably, the water used for preparing the hydrocarbon recovery formulation has a reduced ionic strength namely of 0.15 M or less. The water preferably has an ionic strength of at most 0.1 M or at most 0.05 M, or at most 0.01 M, and may have an ionic strength of from 0.01 M to 0.15 M, or from 0.02 M to 0.125 M, or from 0.0 3M to 0.1 M. Ionic strength, as used herein, is defined by the equation

I=½*Σᵢ₌₁ⁿcᵢzᵢ²

where I is the ionic strength, c is the molar concentration of ion i, z is the valency of ion i, and n is the number of ions in the measured mixture.

It is especially advantageous if the water used for preparing the hydrocarbon recovery formulation contains a limited amount of divalent ions such as less than 4000 ppm, more specifically less than 2000 ppm, more specifically less than 1000 ppm, more specifically less than 500 ppm, more specifically less than 100 ppm, most specifically less than 20 ppm of divalent ions based on total amount of water. More specifically, these amounts relate to the calcium and/or magnesium containing salts.

The water used preferably originates from the formation from which hydrocarbons are to be recovered. Preferably, said water is brine, which is a salt (for example NaCl) containing aqueous solution. Another option is that water is taken from produced water obtained from a hydrocarbon recovery process.

In addition to the surfactant and organic amine, each of the surfactant composition and the hydrocarbon recovery formulation can comprise polymer. The polymer can be added to the surfactant composition before addition of water to dilute the surfactant composition to attain the concentration required for the enhanced hydrocarbon recovery formulation to be injected into the formation, it can be added simultaneous with the water or it can be added after the addition of water. If polymer is added simultaneous with the water it can be added separately or together with the water.

The main function of the polymer is to increase viscosity. That is, the polymer should be a viscosity increasing polymer. The reduction of water mobility may allow the hydrocarbons to be more easily mobilised through the hydrocarbon containing formation. More in particular, the polymer should increase the viscosity of water or an aqueous fluid in which the surfactant composition of the present invention, comprising surfactant and organic amine, has been dissolved thereby producing enhanced hydrocarbon recovery formulation which may be injected into a hydrocarbon containing formation.

Suitable polymers performing the above-mentioned function of increasing viscosity in enhanced hydrocarbon recovery, for use in the present invention, and preparations thereof, are described in U.S. Pat. Nos. 6,427,268, 6,439,308, 5,654,261, 5,284,206, 5,199,490 and 5,103,909.

Suitable commercially available polymers include Flopaam polymer commercially from SNF Floerger, Alcoflood or Aspiro EOR polymer commercially available from Basf, Tramflocas polymer commercially available from Tramfloc Inc., HE polymers commercially available from Chevron Phillips Chemical Co. and further hydrocarbon recovery polymers commercially available from ZL EOR Chemicals Ltd., GuangyaChem, Shandong Xingang Chemical Co. Ltd., Beijing Hengju Nalco and Kemira. A specific suitable polymer commercially available from SNF Floerger is Flopaam 3630 which is a partially hydrolysed polyacrylamide. Flopaam, Alcoflood, Aspiro, Tramflocas and HE are trade names.

The molecular weight of the polymer should be sufficiently high to increase viscosity. Suitably, the molecular weight of the polymer is at least 1 million Dalton, more suitably at least 2 million Dalton, most suitably at least 4 million Dalton. The maximum for the molecular weight of the polymer is not essential. Suitably, the molecular weight of the polymer is at most 30 million Dalton, more suitably at most 25 million Dalton.

Further, the polymer may be a homopolymer, a copolymer or a terpolymer. Still further, the polymer may be a synthetic polymer or a biopolymer or a derivative of a biopolymer. Examples of suitable biopolymers or derivatives of biopolymers include xanthan gum, guar gum, schizophyllan, scleroglucan and chitosan.

A suitable monomer for preparing the polymer is an ethylenically unsaturated monomer of formula R¹R²C═CR³R⁴, wherein at least one of the R¹, R², R³ and R⁴ substituents is a substituent which contains a moiety selected from the group consisting of —C(═O)NH₂, —C(═O)OH, —C(═O)OR wherein R is a branched or linear C₆-C₁₈ alkyl group, —OH, pyrrolidone and —SO₃H (sulfonic acid), and the remaining substituent(s), if any, is (are) selected from the group consisting of hydrogen and alkyl, preferably C₁-C₄ alkyl, more preferably methyl. Most preferably, said remaining substituent(s), if any, is (are) hydrogen. Suitably, a polymer is used that is made from such ethylenically unsaturated monomer.

Suitable examples of the ethylenically unsaturated monomer as defined above, are acrylamide, acrylic acid, lauryl acrylate, vinyl alcohol, vinylpyrrolidone, and styrene sulfonic acid and 2-acrylamido-2-methylpropane sulfonic acid. Suitable examples of ethylenic homopolymers that are made from such ethylenically unsaturated monomers are polyacrylamide, polyacrylate, polylauryl acrylate, polyvinyl alcohol, polyvinylpyrrolidone, and polystyrene sulfonate and poly(2-acrylamido-2-methylpropane sulfonate). For these polymers, the counter cation for the —C(═O)O⁻ moiety (in the case of polyacrylate) and for the sulfonate moiety may be an alkali metal cation, such as a sodium ion, or an ammonium ion.

As mentioned above, copolymers or terpolymers may also be used. Examples of suitable ethylenic copolymers include copolymers of acrylic acid and acrylamide, acrylic acid and lauryl acrylate, and lauryl acrylate and acrylamide.

Preferably, the polymer which may be used in the present invention is a polyacrylamide, more preferably a partially hydrolysed polyacrylamide. A partially hydrolysed polyacrylamide contains repeating units of both —[CH₂—CHC(═O)NH₂]— and —[CH₂—CHC(═O)O⁻M⁺]— wherein M⁺ may be an alkali metal cation, such as a sodium ion, or an ammonium ion. The extent of hydrolysis is not essential and may vary within wide ranges. For example, 1 to 99 mole %, or 5 to 95 mole %, or 10 to 90 mole %, suitably 15 to 40 mole %, more suitably 20 to 35 mole %, of the polyacrylamide may be hydrolysed.

Additionally, a co-solvent may be incorporated either into the surfactant composition or into the hydrocarbon recovery formulation or into both, where the co-solvent may be a low molecular weight alcohol including, but not limited to, methanol, ethanol, and iso-propanol, isobutyl alcohol, secondary butyl alcohol, n-butyl alcohol, t-butyl alcohol, or a glycol including, but not limited to, ethylene glycol, 1,3-propanediol, 1,2-propanediol, diethylene glycol butyl ether, triethylene glycol butyl ether, or a sulfosuccinate including, but not limited to, sodium dihexyl sulfosuccinate.

The co-solvent also can be an alkoxylated low molecular weight alcohol including, but not limited to isobutyl alcohol with 1-15 ethylene oxide groups, preferably 1-4 ethylene oxide groups. The alkylene oxide groups may comprise any alkylene oxide groups. For example, said alkylene oxide groups may comprise ethylene oxide groups, propylene oxide groups and butylene oxide groups or a mixture thereof, such as a mixture of ethylene oxide and propylene oxide groups. In case of a mixture of ethylene oxide and propylene oxide groups, the mixture may be random or blockwise.

The co-solvent may be utilized for assisting in prevention of formation of a viscous emulsion. If present, the co-solvent can be present in an amount of from 100 ppm to 50,000 ppm, or from 500 ppm to 5,000 ppm of the total hydrocarbon recovery formulation. A co-solvent may be absent from the hydrocarbon recovery formulation. The co-solvent can be added as part of the water or as part of the additive solution.

Further, paraffin inhibitor may be incorporated either into the surfactant composition or into the hydrocarbon recovery formulation or into both to inhibit the formation of a viscous paraffin-containing emulsion in the mobilized oil by inhibiting the agglomeration of paraffins in the oil. The mobilized oil, therefore, may flow more freely through the formation for production relative to mobilized oil in which paraffins enhance the formation of viscous emulsions. The paraffin inhibitor of the hydrocarbon recovery formulation may be a compound effective to inhibit or suppress formation of a paraffin-containing emulsion. The paraffin inhibitor may be a compound effective to inhibit or suppress agglomeration of paraffins to inhibit or suppress paraffinic wax crystal growth in the oil of the formation upon contact of the hydrocarbon recovery formulation with the oil in the formation. The paraffin inhibitor may be any commercially available conventional crude oil pour point depressant or flow improver that is dispersible, and can be soluble, in the fluid of the hydrocarbon recovery formulation in the presence of the other components of the hydrocarbon recovery formulation, and that is effective to inhibit or suppress formation of a paraffin-nucleated emulsion in the oil of the formation. The paraffin inhibitor may be selected from the group consisting of alkyl acrylate copolymers, alkyl methacrylate copolymers, alkyl acrylate vinylpyridine copolymers, ethylene vinylacetate copolymers, maleic anhydride ester copolymers, styrene anhydride ester copolymers, branched polyethylenes, and combinations thereof.

The paraffin inhibitor can be added as part of the water or separately. It can be advantageous if the paraffin inhibitor is present in the surfactant composition. Commercially available paraffin inhibitors that may be used in the hydrocarbon recovery formulation include HiTEC 5714, HiTEC 5788, and HiTEC 672 available from Afton Chemical Corp; FLOTRON D1330 available from Champion Technologies; and INFINEUM V300 series available from Infineum International.

The paraffin inhibitor may be present in the hydrocarbon recovery formulation in an amount of from 5 ppm to 5,000 ppm, or from 10 ppm to 1,000 ppm, or from 15 ppm to 500 ppm, or from 20 ppm to 300 ppm based on total amount of formulation.

Furthermore, scale inhibitor may be incorporated either into the surfactant composition or into the hydrocarbon recovery formulation or into both. Scale inhibitors are systems to delay, reduce and/or prevent scale deposition. These include acrylic acid polymers, maleic acid polymers and phosphonates inorganic phosphate, organophosphorous and organic polymer backbones. Examples include phosphonobutane-1,2,4-tricarboxylic acid, amino-trimethylene phosphonic acid and 1-hydroxyethylidene-1,1-diphosphonic acid, polyacrylic acid, phosphinopolyacrylates, polymaleic acids, maleic acid terpolymers, sulfonic acid copolymers, such as sulfonated phosphonocarboxylic acid, and polyvinyl sulfonates. Preferably the scale inhibitors are selected from the group consisting of poly-phosphonocarboxylic acid and diethylenetriamine-penta(methylene phosphonic acid) and mixtures thereof.

Another type of scale inhibitors are chelating agents. Chelating agents can be aminopolycarboxylic or polycarboxylic or carbohydrate in structure, they can be used in the acidic or salt form. Non limiting examples are iminodisuccinic acid, polyaspartic acid, ethylenediamine-N,N′-disuccinic acid, L-glutamic acid N,N-diacetic acid, tetrasodium salt, iminodiacetic acid, nitrilotriacetic acid, ethylenediaminetetraacetic acid, diethylenetriaminepentaacetic acid, citric acid, methylglycine N,N-diacetic acid, glucoheptonic acid, ethanoldiglycinic acid, hydroxyethylethylenediaminetriacetic acid and mixtures thereof.

Therefore, each of the surfactant composition and the hydrocarbon recovery formulation may additionally comprise one or more compounds selected from the group consisting of polymer, paraffin inhibitors, scale inhibitors and co-solvents more specifically such compounds as described above.

The amount of surfactant present in the hydrocarbon recovery formulation may be of from 0.01 to 2 wt. %, preferably 0.05 to 1.5 wt. %, more preferably 0.1 to 1.0 wt. %, most preferably 0.1 to 0.5 wt. %. The amount of polymer (if any) in said hydrocarbon recovery formulation may be of from 0.05 to 2 wt. %, preferably 0.05 to 1.5 wt. %, more preferably 0.05 to 1.0 wt. %, most preferably 0.05 to 0.5 wt. %. The amount of organic amine in the hydrocarbon recovery formulation can be from 0.01 to 2% wt, more specifically from 0.05 to 1% wt, more specifically from 0.1 to 0.6% wt, more specifically from 0.1 to 0.3% wt. All amounts are based on total amount of hydrocarbon recovery formulation. For the amount of organic amine, cation of the organic amine of the surfactant is disregarded.

Generally, it is preferred that a hydrocarbon recovery formulation additionally comprises an alkaline agent and an inorganic salt. Within the present specification, the expression alkaline agent refers to a basic, ionic salt of an alkali metal or alkaline earth metal, preferably an alkali metal, which salt is a base that dissolves in water yielding a solution having a pH greater than 7. Alkaline agents are also commonly referred to as alkalis or alkali agents. The main function of an alkaline agent in a surfactant composition is to lower rock retention or adsorption. Within the present specification, the expression inorganic salt refers to a salt that does not contain carbon atoms. The inorganic salt may be added to create an active formulation to recovery hydrocarbons.

Preferably, the hydrocarbon recovery formulation derived from the present surfactant composition does not require the presence of added alkaline agent or inorganic salt. Therefore, the surfactant composition preferably does not contain these compounds either. Preferably, each of the present surfactant composition and hydrocarbon recovery formulation are prepared by mixing the various components which components do not comprise inorganic salt and which components do not comprise alkaline agent other than organic amine. In other words, it is preferred that the surfactant composition and the hydrocarbon recovery formulation do not comprise added alkaline agent other than organic amine and do not comprise added inorganic salt. Thus, preferably, the surfactant composition of the present invention does not comprise alkaline agent other than organic amine Further, preferably, the surfactant composition of the present invention does not comprise inorganic salt. Thus, preferably, the hydrocarbon recovery formulation does not comprise alkaline agent other than organic amine. Further, preferably, the hydrocarbon recovery formulation does not comprise inorganic salt. Most preferably, the surfactant composition and hydrocarbon recovery formulation do not comprise alkaline agent other than organic amine and do not comprise inorganic salt.

1. Process for preparing a surfactant composition comprising an anionic surfactant and optionally an organic amine in which the molar ratio of the organic amine to the anionic surfactant is preferably at least 1:1 and in which the amount of water is at most 40% by weight,
which process comprises contacting an organic amine and an acid precursor of the anionic surfactant (“acid surfactant precursor”) by adding the acid surfactant precursor to the organic amine, wherein the molar ratio of the organic amine to the total amount of added acid surfactant precursor is at least 1:1, preferably at least 2:1, and the amount of water is at most 40% by weight based on total amount of mixture.

2. A process for recovering oil from an oil-bearing formation, comprising the steps of:
(a) mixing with water a surfactant composition obtained by the process according to claim 1 to form a hydrocarbon recovery formulation;
(b) injecting the hydrocarbon recovery formulation as obtained in step (a) into the oil-bearing formation; and
(c) producing oil from the oil-bearing formation.
